(19) United States
(12) Patent Application Publication
(10) Pub. No.: US 2023/0019184 A1
(43) Pub. Date: Jan. 19, 2023

(54) CONTROL APPARATUS, CONTROL METHOD, AND NON-TRANSITORY COMPUTER READABLE MEDIUM

(71) Applicant: NEC Corporation, Minato-ku, Tokyo (JP)

(72) Inventors: Rintaro Kato, Tokyo (JP); Taketoshi Nakajima, Tokyo (JP); Takamichi Inoue, Tokyo (JP); Shinchi Anami, Tokyo (JP)

(73) Assignee: NEC Corporation, Minato-ku, Tokyo (JP)

(21) Appl. No.: 17/786,662

(22) PCT Filed: Dec. 26, 2019
(86) PCT No.: PCT/JP2019/051202

§ 371 Date: Jun. 17, 2022

(51) Int. Cl. H04W 36/00

(52) U.S. Cl. CPC H04W 36/0069

(57) ABSTRACT

In a control apparatus, a channel selection control unit selects a “switching destination channel pair” from among a plurality of “switching destination channel pair candidates” in a plurality of radio channels. The “switching destination channel pair” is selected based on the degree of similarity between two BSSIDs of two radio channels constituting the currently-connected radio channel pair, and a plurality of degrees of similarity each of which is a degree of similarly between two BSSIDs of two radio channels constituting a respective one of the plurality of switching destination channel pair candidates. A channel switching control unit performs control so that radio units connect to the switching destination channel pair selected by the channel selection control unit.

### TECHNICAL FIELD

The present disclosure relates to a control apparatus, a control method, and a non-transitory computer readable medium.

### BACKGROUND ART

A technology for switching a plurality of connections from one to another based on communication quality has been proposed (e.g., Patent Literature 1). Patent Literature 1 discloses a technology for determining whether or not a communication terminal should switch its connection from a connection with a first radio communication network, which the communication terminal is currently in connection with, to a connection with a second radio communication network by comparing communication quality measured for the connection with the first radio communication network with a threshold.

### CITATION LIST

### Patent Literature

Patent Literature 1: Japanese Unexamined Patent Application Publication No. 2015-165630

### SUMMARY OF INVENTION

### Technical Problem

It should be noted that a radio communication apparatus capable of simultaneously connecting to a plurality of radio channels has been being discussed. The inventors of the present application have found that when switching is performed for each of connected radio channels based on a switching criterion disclosed in Patent Literature 1, there is a high possibility that a plurality of radio communication apparatuses are connected to a radio channel of one access point, so that there is a high possibility that a spatial diversity effect may not be obtained.

An object of the present disclosure is to provide a control apparatus, a control method, and a non-transitory computer readable medium capable of improving the spatial diversity effect of a radio communication apparatus.

### Solution to Problem

A control apparatus according to a first aspect is a control apparatus configured to control communication of a radio communication apparatus capable of simultaneously connecting to a plurality of radio channels, the control apparatus including:

a channel selection control unit configured to select a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and

a channel switching control unit configured to make the radio communication apparatus connect to the switching destination channel pair selected for the radio communication apparatus.

A control method according to a second aspect is a control method performed by a control apparatus configured to control communication of a radio communication apparatus capable of simultaneously connecting to a plurality of radio channels, the control method including:

selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and

making the radio communication apparatus connect to the switching destination channel pair selected for the radio communication apparatus.

A non-transitory computer-readable medium according to a third aspect stores a control program for causing a control apparatus configured to control communication of a radio communication apparatus capable of simultaneously connecting to a plurality of radio channels to perform processes including:

selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and

making the radio communication apparatus connect to the switching destination channel pair selected for the radio communication apparatus.

### Advantageous Effects of Invention

According to the present disclosure, it is possible to provide a control apparatus, a control method, and a non-transitory computer readable medium capable of improving the spatial diversity effect of a radio communication apparatus.

### BRIEF DESCRIPTION OF DRAWINGS

FIG. 1 shows an example of a communication system according to a first example embodiment;

FIG. 2 is a block diagram showing an example of a radio terminal including a control apparatus according to the first example embodiment;

FIG. 3 is a flowchart showing an example of processing operations performed by the radio terminal according to the first example embodiment;

FIG. 4 shows an example of an AP list according to a second example embodiment;

FIG. 5 is a block diagram showing an example of a radio terminal including a control apparatus according to a third example embodiment;

FIG. 6 shows an example of an AP list according to the third example embodiment;

FIG. 7 shows an example of a communication system according to a fourth example embodiment; and

FIG. 8 shows an example of a hardware configuration of a control apparatus.

### DESCRIPTION OF EMBODIMENTS

An example embodiment will be described hereinafter with reference to the drawings. Note that in the example embodiment, the same or equivalent components are denoted by the same reference numerals (or symbols), and redundant descriptions thereof will be omitted.

### First Example Embodiment

### <Overview of Communication System>

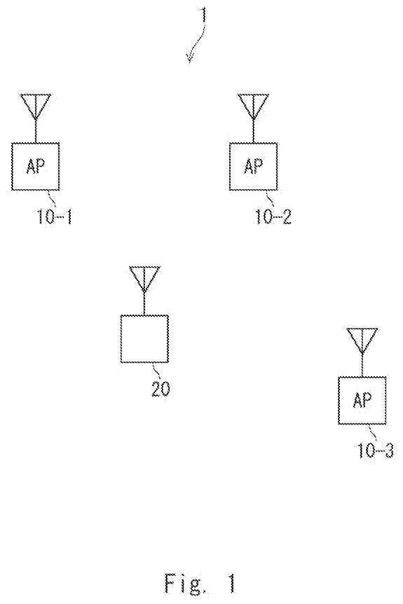

FIG. 1 shows an example of a communication system according to a first example embodiment. The communication system 1 is, for example, a wireless LAN communication system. In FIG. 1, the communication system 1 includes access points (APs) 10-1 to 10-3, and a radio terminal (a radio communication apparatus) 20. Note that, in the following description, when the APs 10-1 to 10-3 are not distinguished from each other, the APs 10-1 to 10-3 may be simply referred to as APs 10. Although three APs 10 and one radio terminal 20 are shown for simplifying the description in this example, the number of APs 10 and the number of radio terminals 20 included in the communication system 1 are not limited to the aforementioned numbers.

For example, the AP 10-1 has a plurality of radio channels (hereinafter also referred to as a “first channel set”). Further, for example, each of the APs 10-2 and 10-3 has at least one radio channel. Note that the plurality of radio channels of the AP 10-1 (i.e., the first channel set) and the radio channels of the APs 10-2 and 10-3, as a whole, may also be referred to as a “radio channel group”.

The radio terminal 20 includes a plurality of radio units 21 (which will be described later), and the plurality of radio units 21 can connect to one or a plurality of radio channels.

### <Example of Configuration of Radio Terminal>

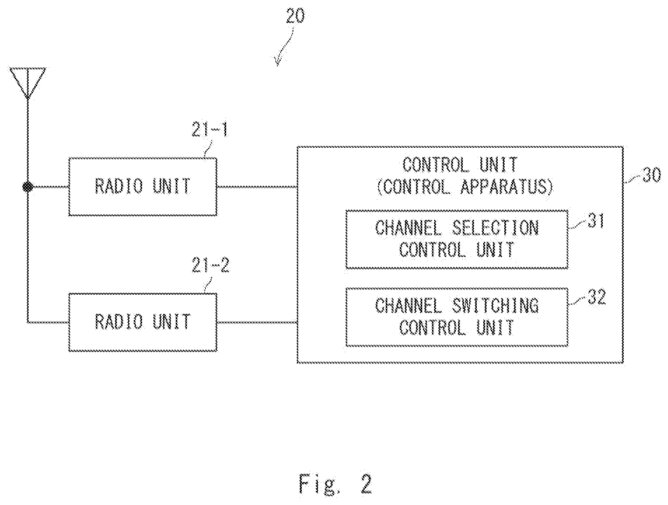

FIG. 2 is a block diagram showing an example of a radio terminal including a control apparatus according to the first example embodiment. In FIG. 2, the radio terminal 20 includes radio units (radio interface units) 21-1 and 21-2, and a control unit (a control apparatus) 30. Note that although same one antenna is commonly used by both the radio units 21-1 and 21-2 in the radio terminal 20 shown in FIG. 2, the configuration of the radio terminal 20 is not limited to this example. That is, the radio terminal 20 may include an antenna corresponding to the radio unit 21-1 and an antenna corresponding to the 21-2, respectively.

The radio units 21-1 and 21-2 can both connect to the same one radio channel, or a plurality of different radio channels, respectively. That is, both the radio units 21-1 and 21-2 may connect to the same one radio channel, or the radio units 21-1 and 21-2 may connect to radio channels different from each other. Note that each of the radio units 21-1 and 21-2 may, as its original function, automatically connect to a radio channel having an excellent communication quality (e.g., an excellent received signal strength) at the time of the initial connection (e.g., when the radio unit connects to a radio channel for the first time).

The control unit (the control apparatus) 30 includes a channel selection control unit 31 and a channel switching control unit 32.

The channel selection control unit 31 selects a “switching destination channel pair” from among a plurality of “switching destination channel pair candidates” in a plurality of radio channels included in the “radio channel group”. For example, the “switching destination channel pair” is selected based on the degree of similarity between two BSSIDs (Basic Service Set Identifiers) of two radio channels constituting the currently-connected radio channel pair (i.e., the radio channel pair with which the radio terminal 20 is currently in connection), and a plurality of degrees of similarity each of which is a degree of similarly between two BSSIDs of two radio channels constituting a respective one of the above-described plurality of switching destination channel pair candidates.

The channel switching control unit 32 is a functional unit that controls switching of the radio channels to which the radio units 21 connect. The channel switching control unit 32 performs control so as to make the radio units 21-1 and 21-2 connect to the switching destination channel pair selected by the channel selection control unit 31.

### <Example of Operation of Radio Terminal>

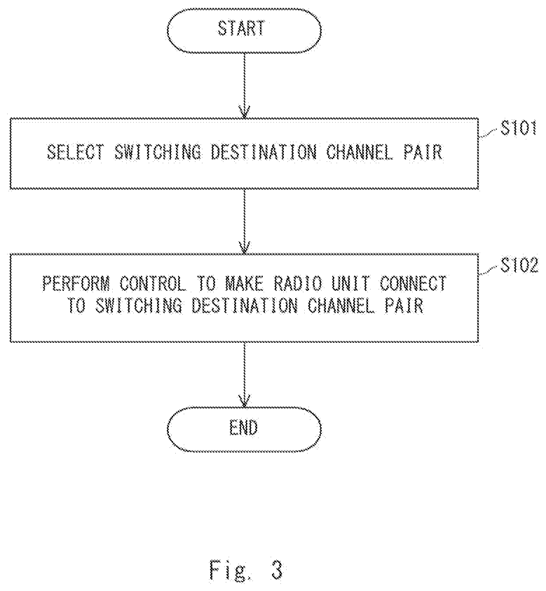

An example of processing operations performed by the radio terminal 20 having the above-described configuration will be described. In particular, processing operations performed by the control unit (the control apparatus) 30 will be described hereinafter. FIG. 3 is a flowchart showing an example of processing operations performed by the radio terminal according to the first example embodiment.

The channel selection control unit 31 selects a “switching destination channel pair” from among a plurality of “switching destination channel pair candidates” in a plurality of radio channels included in the “radio channel group” (Step S101). The “switching destination channel pair” is selected based on the degree of similarity between two BSSIDs (Basic Service Set Identifiers) of two radio channels constituting the currently-connected radio channel pair, and a plurality of degrees of similarity each of which is a degree of similarly between two BSSIDs of two radio channels constituting a respective one of the above-described plurality of switching destination channel pair candidates.

The channel switching control unit 32 performs control so as to make the radio units 21-1 and 21-2 connect to the switching destination channel pair selected by the channel selection control unit 31. (Step S102).

As described above, according to the first example embodiment, in the control apparatus 30, the channel selection control unit 31 selects a “switching destination channel pair” from among a plurality of “switching destination channel pair candidates” in a plurality of radio channels. The “switching destination channel pair” is selected based on the degree of similarity between two BSSIDs of two radio channels constituting the currently-connected radio channel pair, and a plurality of degrees of similarity each of which is a degree of similarly between two BSSIDs of two radio channels constituting a respective one of the above-described plurality of switching destination channel pair candidates.

By the above-described configuration of the control apparatus 30, it is possible to improve the spatial diversity effect of the radio terminal 20. That is, a second pair of two BSSIDs having a degree of similarity therebetween lower than that between a first pair of two BSSIDs is more likely to be a pair of BSSIDs of APs different from each other than the first pair of two BSSIDs is. Therefore, by selecting a “switching destination channel pair” based on the degree of similarity between two BSSIDs of two radio channels constituting the currently-connected radio channel pair, and a plurality of degrees of similarity each of which is a degree of similarly between two BSSIDs of two radio channels constituting a respective one of the above-described plurality of switching destination channel pair candidates, it is possible to select a “switching destination channel pair” composed of two radio channels corresponding to BSSIDs of APs different from each with a high probability. As a result, it is possible to improve the spatial diversity effect of the radio terminal 20.

Note that, as described above, each of the radio units 21-1 and 21-2 may, as its original function, automatically connect to a radio channel having an excellent communication quality (e.g., an excellent received signal strength) at the time of the initial connection. In this case, at the time of the initial connection, the possibility that both the radio units 21-1 and 21-2 connect to, for example, one or two radio channels of the AP 10-1 increases. As a result, there is a possibility that the spatial diversity effect decreases at the time of the initial connection. However, as the radio channel pair is switched to the “switching destination channel pair” selected by the channel selection control unit 31, the spatial diversity effect can be improved.

Further, the “switching destination channel pair candidates” may be limited to those including radio channels having a predetermined communication quality level or higher.

### Second Example Embodiment

A second example embodiment relates to a more specific example embodiment of the first example embodiment. Note that the fundamental configurations of a communication system, a radio terminal, and a control apparatus according to the second example embodiment are similar to those of the communication system 1, the radio terminal 20, and the control apparatus 30 according to the first example embodiment. Therefore, they will be described with reference to FIGS. 1 and 2.

In the second example embodiment, the channel selection control unit 31 of the control apparatus 30 selects, as a switching destination channel pair, a switching destination channel pair candidate composed of two radio channels having a degree of similarity between BSSIDs thereof lower than that between two BSSIDs of two radio channels constituting the currently-connected radio channel pair. For example, the channel selection control unit 31 selects, from among a plurality of switching destination channel candidates, a switching destination channel candidate corresponding to a BSSID of which the degree of similarity with the BSSID of a first radio channel is lower than that between the BSSIDs of the first radio channel and a second radio channel, which constitute the currently-connected radio channel pair, as the switching destination channel. In this way, the channel selection control unit 31 can select the first radio channel and the selected switching destination channel as the switching destination channel pair. For example, the radio unit 21-1 may be used for communication, and the first radio channel set in the radio unit 21-1 may be an “in-use channel”. Further, the second radio channel set in the radio unit 21-2 may be a “standby channel”. In this case, the channel selection control unit 31 may select the switching destination channel of the radio channel set in the radio unit 21-2 while maintaining the radio channel set in the radio unit 21-1. Note that the first and second radio channels may be one radio channel (i.e., the same radio channel) of one AP 10, two different radio channels of one AP 10, or two different radio channels of two APs 10 different from each other. Further, the channel selection control unit 31 may exclude radio channels whose communication qualities are lower than or equal to a predetermined level from the above-described switching destination channel candidates.

Note that the BSSID contains six octets. In general, the highest three octets of these six octets correspond to a vendor ID, and the next one octet corresponds to a model ID. Further, the lowest two octets correspond to a serial ID. Therefore, it is possible to specify the model name of a network apparatus based on the highest four octets.

Therefore, the channel selection control unit 31 may determine a BSSID of which the highest four octets of the six octets are different from those of the BSSID of the above-described first radio channel to be a “low-similarity BSSID”, and preferentially select a switching destination channel candidate corresponding to this low-similarity BSSID as the switching destination channel. Preferably, the channel selection control unit 31 may determine a BSSID of which the highest three octets of the six octets are different from those of the BSSID of the above-described first radio channel to be a “low-similarity BSSID”, and preferentially select a switching destination channel candidate corresponding to this low-similarity BSSID as the switching destination channel. That is, the channel selection control unit 31 may preferentially select, as the switching destination channel, a switching destination channel candidate corresponding to a BSSID of which the position of the octet which is different from that of the BSSID of the above-described first radio channel is higher than those of other BSSIDs.

Note that there is a possibility that two BSSIDs of which the highest four octets of the six octets are the same as each other but the lowest two octets are not continuous with each other (i.e., not consecutive to each other) are radio channels of two APs different from each other. Therefore, the channel selection control unit 31 may determine a BSSID of which the highest four octets of the six octets are the same as those of the BSSID of the above-described first radio channel but the lowest two octets thereof are not continuous with those of the BSSID of the above-described first radio channel to be a “low-similarity BSSID”, and preferentially select a switching destination channel candidate corresponding to this low-similarity BSSID as the switching destination channel.

For example, in particular, in the case where there is no switching destination channel candidate corresponding to a BSSID of which the highest four octets of the six octets are different from those of the BSSID of the above-described first radio channel, the channel selection control unit 31 may determine a BSSID of which the lowest two octets are not continuous with those of the BSSID of the above-described first radio channel to be a “low-similarity BSSID”, and preferentially select a switching destination channel candidate corresponding to this low-similarity BSSID as the switching destination channel.

That is, the degree of similarity of a BSSID of which the highest three octets of the six octets are different from those of the BSSID of the above-described first radio channel is regarded as the lowest; the degree of similarity of a BSSID of which the fourth octet of the six octets is different from that of the BSSID of the above-described first radio channel is regarded as the second lowest; and the degree of similarity of a BSSID of which the lowest two octets are not continuous with those of the BSSID of the above-described first radio channel is regarded as the third lowest. Then, the lower the degree of similarity of a BSSID is, the more preferentially a switching destination channel candidate corresponding to this BSSID may be selected. For example, when there are a first switching destination channel candidate corresponding to a BSSID of which the highest three octets of the six octets are different from those of the BSSID of the above-described first radio channel, a second switching destination channel candidate corresponding to a BSSID of which the fourth octet is different from that of the BSSID of the above-described first radio channel, and a third switching destination channel candidate corresponding to a BSSID of which the lowest two octets are not continuous with those of the BSSID of the above-described first radio channel, the first switching destination channel candidate, which corresponds to the BSSID of which the degree of similarity is regarded as the lowest, is selected as the switching destination channel.

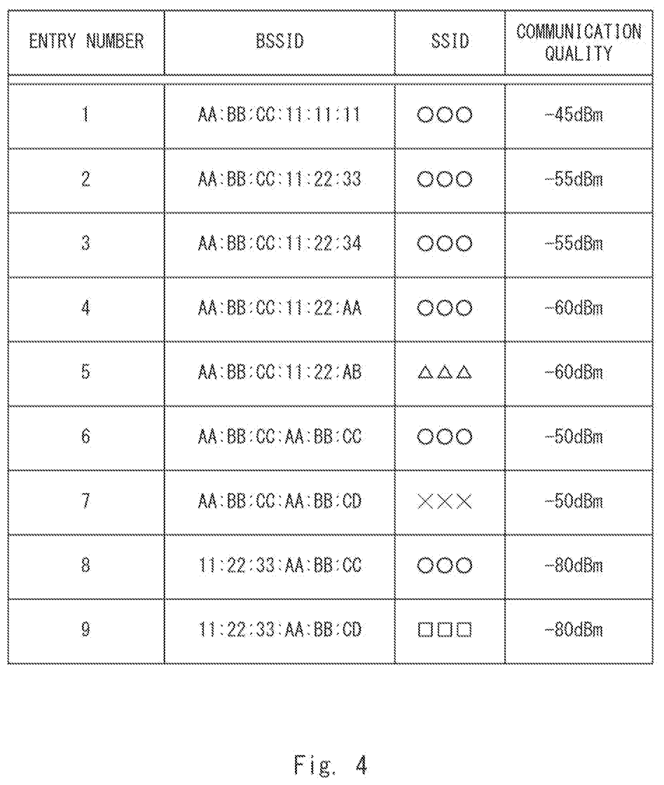

FIG. 4 shows an example of an AP list (a radio channel list) according to the second example embodiment. The AP list can be created by channel scanning. In the AP list shown in FIG. 4, each entry includes an entry number, a BSSID, an SSID, and a communication quality. Although the communication quality is, as an example, an RSSI in FIG. 4, the communication quality may be an available bandwidth, an S/N (Signal-to-Noise) ratio, an error rate, or the like. In the AP list shown in FIG. 4, the highest four octets of the BSSID of each of the entry numbers 6 to 9 differ from those of the BSSIDs of the entry numbers 1 to 5. Therefore, for example, when both the radio units 21-1 and 21-2 are in connection with a radio channel corresponding to the BSSID of the entry number 1, the channel selection control unit 31 may select a radio channel corresponding to one of the BSSIDs of the entry number 6 to 9 as the switching destination channel for the radio unit 21-2. Alternatively, the channel selection control unit 31 may select, as the switching destination channel for the radio unit 21-2, a radio channel corresponding to either of the entry numbers 8 and 9 having BSSIDs of each of which the position of the octet which is different from that of the BSSID of the entry number 1 corresponding to the radio unit 21-1 is higher than those of other entry numbers.

Further, in the AP list shown in FIG. 4, the entries of the entry numbers 1, 2 (3), and 4 (5) have the same highest four octets as each other, but their lowest two octets are not continuous with each other. Therefore, for example, when both the radio units 21-1 and 21-2 are in connection with a radio channel corresponding to the BSSID of the entry number 1, the channel selection control unit 31 may select the BSSID of either of the entry numbers 2 and 3, or the BSSID of either of the entry numbers 4 and 5 as the switching destination channel for the radio unit 21-2.

Note that, as described above, the channel selection control unit 31 may exclude radio channels whose communication qualities are lower than or equal to a predetermined level from the above-described switching destination channel candidates. For example, when the predetermined level is −70 dBm, the channel selection control unit 31 may exclude the radio channels corresponding to the BSSIDs of the entry numbers 8 and 9 from the above-described switching destination channel candidates. In this case, the channel selection control unit 31 may select a radio channel corresponding to the BSSID of either of the entry numbers 7 and 8 as the switching destination channel for the radio unit 21-2.

The channel switching control unit 32 makes the radio terminal 20 disconnect the above-described second radio channel and connect to the switching destination channel selected by the channel selection control unit 31.

As described above, according to the second example embodiment, in the control apparatus 30, the channel selection control unit 31 selects, as a switching destination channel pair, a switching destination channel pair candidate composed of two radio channels having a degree of similarity between BSSIDs thereof lower than that between two BSSIDs of two radio channels constituting the currently-connected radio channel pair. The channel switching control unit 32 makes the radio terminal 20 connect to the switching destination channel pair selected by the channel selection control unit 31.

By the above-described configuration of the control apparatus 30, it is possible to increase the possibility that the radio units 21-1 and 21-2 connect to radio channels of APs different from each other, and thereby to improve the spatial diversity effect.

For example, in the control apparatus 30, as the switching destination channel, the channel selection control unit 31 selects, from among a plurality of switching destination channel candidates, a switching destination channel candidate corresponding to a BSSID of which the degree of similarity with the BSSID of the first radio channel is lower than that between the BSSIDs of the first and second radio channels constituting the currently-connected radio channel pair. In this way, the channel selection control unit 31 selects the first radio channel and the selected switching destination channel as the switching destination channel pair. Then, the channel switching control unit 32 makes the radio terminal 20 disconnect the above-described second radio channel and connect to the switching destination channel selected by the channel selection control unit 31.

### Third Example Embodiment

Similarly to the second example embodiment, a third example embodiment relates to a more specific example embodiment of the first example embodiment. However, in the third example embodiment, the switching destination channel is selected based on the degree of similarity between (i.e., the degree of closeness of) channel frequencies in addition to the degree of similarity between BSSIDs. Since the fundamental configuration of the communication system according to the second example embodiment is similar to that of the communication system 1 according to the first example embodiment, it will be described with reference to FIG. 1. That is, the communication system 1 according to the third example embodiment may be one that is obtained by replacing the radio terminal 20 with a radio terminal 40 (which will be described later) in FIG. 1.

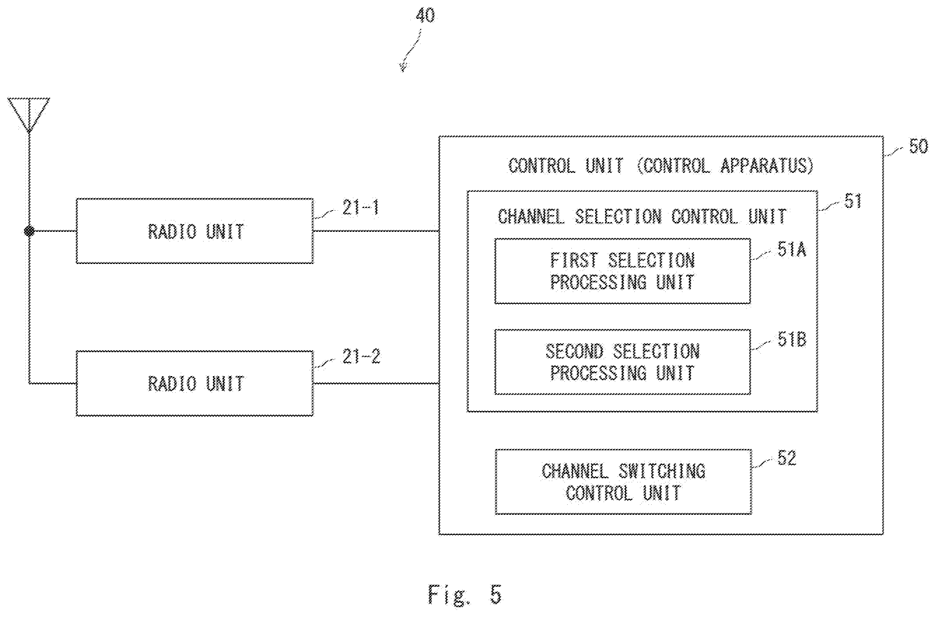

FIG. 5 is a block diagram showing an example of a radio terminal including a control apparatus according to a third example embodiment. In FIG. 5, the radio terminal 40 includes radio units 21-1 and 21-2, and a control unit (a control apparatus) 50. Note that although same one antenna is commonly used by both the radio units 21-1 and 21-2 in the radio terminal 40 shown in FIG. 5, the configuration of the radio terminal 40 is not limited to this example. That is, the radio terminal 40 may include an antenna corresponding to the radio unit 21-1 and an antenna corresponding to the 21-2, respectively.

The control unit (the control apparatus) 50 includes a channel selection control unit 51 and a channel switching control unit 52. The channel selection control unit 51 includes a first selection processing unit 51A and a second selection processing unit 51B.

The first selection processing unit 51A selects, from among a plurality of “switching destination channel candidates”, a switching destination channel candidate corresponding to a BSSID of which the degree of similarity with the BSSID of the first radio channel is lower than that between the BSSIDs of the first and second radio channels constituting the currently-connected radio channel pair as a “temporarily-determined switching destination channel”. Here, it is assumed that the first radio channel is the radio channel set in the radio unit 21-1 and the second radio channel is the radio channel set in the radio unit 21-2. Note that the first and second radio channels may be one radio channel (i.e., the same radio channel) of one AP 10, two different radio channels of one AP 10, or two different radio channels of two APs 10 different from each other. Further, the degree of similarity between BSSIDs has already been described in the second example embodiment, and it also applies hereinafter.

When a plurality of temporarily-determined switching destination channels are selected by the first selection processing unit 51A, the second selection processing unit 51B preferentially selects, from among the plurality of temporarily-determined switching destination channels, a temporarily-determined switching destination channel corresponding to a channel frequency of which the degree of similarity with the channel frequency of the first radio channel is low as a “switching destination channel”. In this way, the second selection processing unit 51B can select the above-described first radio channel and the selected switching destination channel as the “switching destination channel pair”.

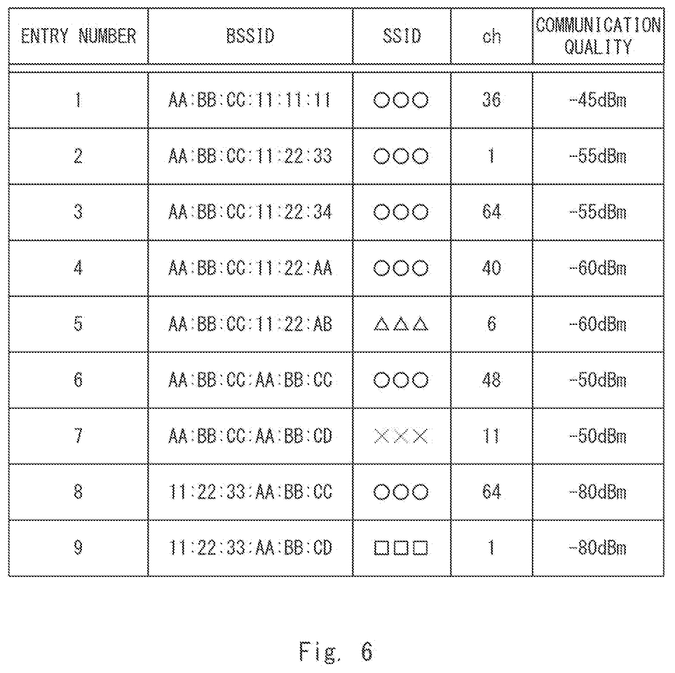

FIG. 6 shows an example of an AP list (a radio channel list) according to the third example embodiment. The AP list can be created by channel scanning. The AP list shown in FIG. 6 differs from that shown in FIG. 4 in that it includes an item (i.e., a column) “Channel Number (ch)”. In the AP list shown in FIG. 6, each entry includes an entry number, a BSSID, an SSID, a channel number, and a communication quality. In the AP list shown in FIG. 6, the highest four octets of the BSSIDs of each of the entry numbers 6 to 9 differ from those of the BSSIDs of the entry numbers 1 to 5. Therefore, for example, when both the radio units 21-1 and 21-2 are in connection with a radio channel corresponding to the BSSID of the entry number 1, the first selection processing unit 51A may select a radio channel corresponding to one of the BSSIDs of the entry number 6 to 9 as the “temporarily-determined switching destination channel” for the radio unit 21-2. Alternatively, the channel selection control unit 31 may select, as the “temporarily-determined switching destination channel” for the radio unit 21-2, a radio channel corresponding to either of the entry numbers 8 and 9 having BSSIDs of each of which the position of the octet which is different from that of the BSSID of the entry number 1 corresponding to the radio unit 21-1 is higher than those of other entry numbers.

Further, similarly to the second example embodiment, in the AP list shown in FIG. 6, the entries of the entry numbers 1, 2, 3, 4 and 5 have the same highest four octets as each other, but their lowest two octets are not continuous with each other. Therefore, for example, when both the radio units 21-1 and 21-2 are in connection with a radio channel corresponding to the BSSID of the entry number 1, the channel selection control unit 31 may select the BSSID of either of the entry numbers 2 and 3, or the BSSID of either of the entry numbers 4 and 5 as the “temporarily-determined switching destination channel” for the radio unit 21-2.

Here, it is assumed that the first selection processing unit 51A excludes the radio channels of the entry numbers 8 and 9 of each of which the communication quality is −70 dBm or lower, and select, as “temporarily-determined switching destination channels” for the radio unit 21-2, the radio channels of the entry numbers 6 and 7 having BSSIDs of each of which the position of the octet which is different from that of the BSSID of the entry number 1 corresponding to the radio unit 21-1 is higher than those of other entry numbers.

In the AP list shown in FIG. 6, the channel number of the entry number 1 with which the radio unit 21-1 is in connection is “36”. Further, the channel numbers of the entry numbers 6 and 7, which are selected as the “temporarily-determined switching destination channels” are “48” and “11”, respectively. In this state, the second selection processing unit 51B may select, as the “switching destination channel”, the “temporarily-determined switching destination channel” corresponding to the channel number “11”, which is far from (i.e., widely different from) the channel number “36”. In this way, it is possible to increase the possibility of selecting a “switching destination channel” which is less likely to cause interference with the in-use channel.

Alternatively, the second selection processing unit 51B may select, as the “switching destination channel”, one of the radio channels of the entry numbers 6 and 7 selected as the “temporarily-determined switching destination channels” of which the communication quality is higher than that of the other radio channel. That is, the channel number “42” of the entry number 6 is in a 5.0 GHz band, while the channel number “11” of the entry number 7 is in a 2.4 GHz band. The 2.4 GHz band partially overlaps with the ISM band, it is likely to be congested. In other words, the 5.0 GHz band is likely to be less congested than the 2.4 GHz band is. Therefore, by selecting, as the “switching destination channel”, one of the radio channels of the entry numbers 6 and 7 selected as the “temporarily-determined switching destination channels” of which the communication quality is higher than that of the other radio channel, the probability that the radio channel of the entry number 6 in the 5.0 GHz band is selected as the “switching destination channel” increases. Further, when the radio channels of the entry numbers 6 and 7 selected as the “temporarily-determined switching destination channels” have communication qualities equal to each other, the second selection processing unit 51B may select, as the “switching destination channel”, a radio channel having the same SSID as that of the radio channel currently set in the radio unit 21-2. In this example, the radio channel of the entry number 6 having the same SSID as the SSID “000” of the radio channel of the entry number 1 currently set in the radio unit 21-2 is selected as the “switching destination channel”.

Further, assume a case where, as the “temporarily-determined switching destination channels”, there are radio channels having entry numbers 6′ and 7′ in addition to the above-described radio channels of the entry numbers 6 and 7. It is assumed that the entry number 6′ includes a BSSID “AA:BB:CC:AA:11:11”, a ch (i.e., a channel) “52”, and a communication quality “−45 dBm”, and the entry number 7′ includes a BSSID “AA:BB:CC:AA:11:12”, a ch “13”, and a communication quality “−45 dBm”. In this case, the second selection processing unit 51B selects the radio channel of the entry number 7 corresponding to, among the channel numbers “13” and “11” corresponding to the 2.4 GHz band, the channel number “11” which is a far from (i.e., widely different from) the channel number “36”. Further, the second selection processing unit 51B selects the radio channel of the entry number 6′ corresponding to, among the channel numbers “48” and “52” corresponding to the 5.0 GHz band, the channel number “52” which is a far from (i.e., widely different from) the channel number “36”. Then, the second selection processing unit 51B may select, from among the radio channels of the entry numbers 7 and 6′, the radio channel of the entry number 6′ of which the communication quality is better than that of the other entry number 7 as the “switching destination channel”.

Note that, in the example described above, the first selection processing unit 51A excludes “switching destination channel candidates” of which the communication qualities are −70 dBm or lower from the “temporarily-determined switching destination channels”. Alternatively or additionally, the first selection processing unit 51A may exclude “switching destination channel candidates” whose SSIDs are different from that of the radio channel currently set in the radio unit 21-2 from the “temporarily-determined switching destination channels”.

The channel switching control unit 52 makes the radio terminal 40 disconnect the above-described second radio channel and connect to the switching destination channel selected by the second selection processing unit 51B.

As described above, according to the third example embodiment, in the control apparatus 50, the first selection processing unit 51A selects, from among a plurality of “switching destination channel candidates”, a switching destination channel candidate corresponding to a BSSID of which the degree of similarity with the BSSID of the first radio channel is lower than that between the BSSIDs of the first and second radio channels constituting the currently-connected radio channel pair as a “temporarily-determined switching destination channel”. When a plurality of temporarily-determined switching destination channels are selected by the first selection processing unit 51A, the second selection processing unit 51B preferentially selects, from among the plurality of temporarily-determined switching destination channels, a temporarily-determined switching destination channel corresponding to a channel frequency of which the degree of similarity with the channel frequency of the first radio channel is low as a “switching destination channel”.

By the above-described configuration of the control apparatus 50, it is possible to increase the possibility that the radio units 21-1 and 21-2 connect to radio channels that are those of APs different from each other and are less likely to cause interference therebetween, and thereby to improve the spatial diversity effect and reduce the inter-channel interference.

### Fourth Example Embodiment

A fourth example embodiment relates to an example of use of two radio channels to which the radio units 21-1 and 21-2 connect.

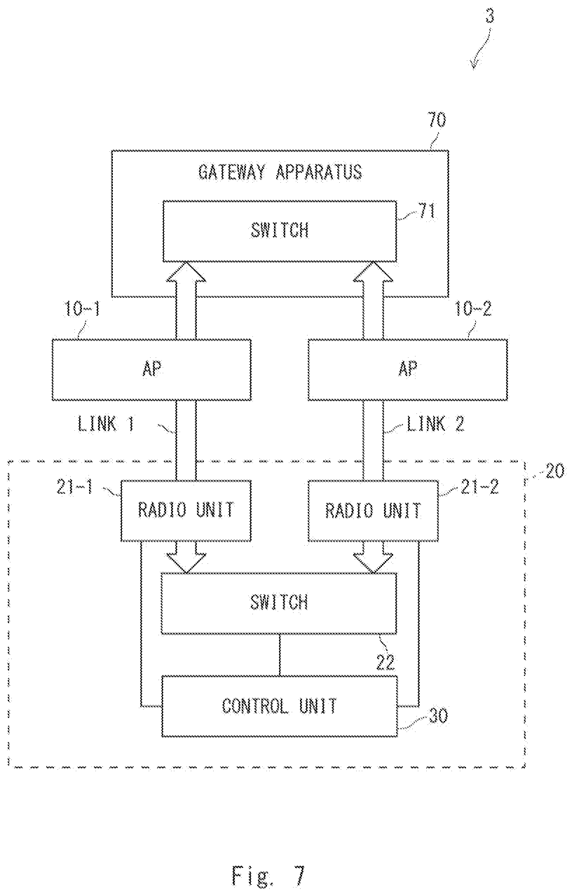

FIG. 7 shows an example of a communication system according to the fourth example embodiment. In FIG. 7, the communication system 3 includes APs 10-1 and 10-2, a radio terminal 20, and a gateway apparatus 70.

FIG. 7 shows, for example, a state in which the radio unit 21-1 of the radio terminal 20 connects to the radio channel of the AP 10-1 and the radio unit 21-2 connects to the radio channel of the AP 10-2 by the method described in the first to third example embodiments. In this way, a link 1 is established between the radio terminal 20 and the gateway apparatus 70 through the AP 10-1, and a link 2 is established between them through the AP 10-2.

The control unit 30 (the channel switching control unit 32) assigns a common tunnel ID (e.g., a VLANID) to the links 1 and 2. In this way, the links 1 and 2 can be tunneled.

Further, the control unit 30 (the channel switching control unit 32) acquires a communication quality parameter value of the radio channel set in the radio unit 21-1 from the radio unit 21-1, and acquires a communication quality parameter value of the radio channel set in the radio unit 21-2 from the radio unit 21-2. For example, one of the two radio channels set in the radio units 21-1 and 21-2, respectively, is an “in-use channel” used for communication, and the other radio channel is a “standby channel”. In the following description, the communication quality parameter value for the in-use channel is also referred to as a “first communication quality parameter value” and the communication quality parameter value for the standby channel is referred to as a “second communication quality parameter value”.

The control apparatus 30 determines whether or not the radio channel set as the standby channel should be switched from the standby channel to the in-use channel based on the acquired “first communication quality parameter value” and the “second communication quality parameter value”. Further, when the control apparatus 30 has determined to switch the radio channel, it outputs a switching control signal to a switch 22. As a result, the switch 22 switches the radio channel set as the standby channel from the standby channel to the in-use channel, and switches the radio channel set as the in-use channel from the in-use channel to the standby channel. For example, in the state in which the radio channel of the radio unit 21-1 is set as the in-use channel and the radio channel of the radio unit 21-2 is set as the standby channel, when the switch 22 receives the aforementioned switching control signal, it switches the radio channel of the radio unit 21-2 from the standby channel to the in-use channel and switches the radio channel of the radio unit 21-1 from the in-use channel to the standby channel. As described above, since the common tunnel ID is assigned to the links 1 and 2, signals can be transmitted and received between the switch 22 and a switch 71 by using this common tunnel ID even when the in-use link, i.e., the link used for communication, is switched.

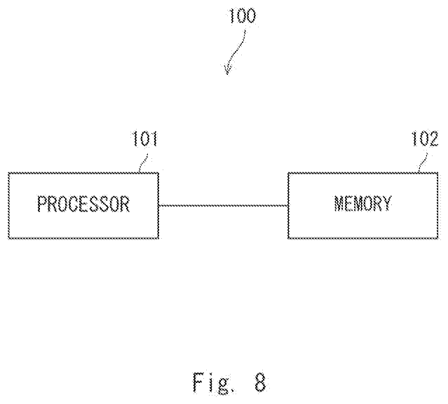

### Other Example Embodiment

<1> In each of the first and second example embodiments, a method for selecting a “switching destination channel pair” based on the degree of similarity of BSSIDs has been described, but the present disclosure is not limited to this method. For example, a “switching destination channel pair” may be selected based on, instead of the degree of similarity between BSSIDs, the degree of similarity between channel frequencies described in the third example embodiment. In this case, for example, in the control apparatus 30, the channel selection control unit 31 selects a “switching destination channel pair” from among a plurality of “switching destination channel pair candidates” in a plurality of radio channels. The “switching destination channel pair” is selected based on the degree of similarity between two channel frequencies of two radio channels constituting the currently-connected radio channel pair, and a plurality of degrees of similarity each of which is a degree of similarly between two channel frequencies of two radio channels constituting a respective one of the plurality of switching destination channel pair candidates.
<2> In order to improve the spatial diversity effect of a radio terminal, it is conceivable to use a configuration of a radio terminal described below. That is, a radio terminal may prepare in advance a table in which a plurality of channel pairs, each channel pair including two radio channels of APs which are different from each other, are defined, and may connect to one of the channel pairs defined in the table.
<3> In order to improve the spatial diversity effect of a radio terminal, it is conceivable to use a method described below. For example, when two radio units of a radio terminal are in connection with a radio channel of one AP, an apparatus on the host side of this AP (i.e., a host apparatus) may control the AP so that the AP disconnects the radio channel corresponding to one of the radio units of the AP. As a result, since the radio terminal reconnects the disconnected one of the radio units to other radio channels, thus making it possible to increase the possibility that the two radio units are connected to different APs.
<4> FIG. 8 shows an example of a hardware configuration of a control apparatus. In FIG. 8, a control apparatus 100 includes a processor 101 and a memory 102. The processor 101 may be, for example, a microprocessor, an MPU (Micro Processing Unit), or a CPU (Central Processing Unit). The processor 101 may include a plurality of processors. The memory 102 is composed of a combination of a volatile memory and a nonvolatile memory. The memory 102 may include a storage located remotely from the processor 101. In this case, the processor 101 may access the memory 102 through an I/O interface (not shown).

Each of the control apparatuses 30 and 50 according to the first to fourth example embodiments may have the hardware configuration shown in FIG. 8. Each of the channel selection control units 31 and 51, and the channel switching control units 32 and 52 of the control apparatuses 30 and 50 according to the first to fourth example embodiments may be implemented by having the processor 101 load a program stored in the memory 102 and execute the loaded program. The program may be stored in various types of non-transitory computer readable media and thereby supplied to each of the control apparatuses 30 and 50. Examples of the non-transitory computer readable media include a magnetic recording medium (such as a flexible disk, a magnetic tape, and a hard disk drive) and a magneto-optic recording medium (such as a magneto-optic disk). Further, examples of the non-transitory computer readable media include CD-ROM (Read Only Memory), CD-R, and CD-R/W. Further, examples of the non-transitory computer readable media include a semiconductor memory. The semiconductor memory includes, for example, a mask ROM, a PROM (Programmable ROM), an EPROM (Erasable PROM), a flash ROM, and a RAM (Random Access Memory). Further, the programs may be supplied to each of the control apparatuses 30 and 50 by using various types of transitory computer readable media. Examples of the transitory computer readable media include an electrical signal, an optical signal, and an electromagnetic wave. The transitory computer readable media can be used to supply a program to each of the control apparatuses 30 and 50 through a wired communication line (e.g., an electric wire and an optical fiber) or a radio communication line.

Although the present invention is described above with reference to example embodiments, the present invention is not limited to the above-described example embodiments. Various modifications that can be understood by those skilled in the art can be made to the configuration and details of the present invention within the scope of the invention.

The whole or part of the example embodiments disclosed above can be described as, but not limited to, the following supplementary notes.

### (Supplementary Note 1)

A control apparatus configured to control communication of a radio communication apparatus capable of simultaneously connecting to a plurality of radio channels, the control apparatus comprising:

a channel selection control unit configured to select a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and

a channel switching control unit configured to make the radio communication apparatus connect to the switching destination channel pair selected for the radio communication apparatus.

### (Supplementary Note 2)

The control apparatus described in Supplementary note 1, wherein the channel selection control unit selects, as the switching destination channel pair, a switching destination channel pair candidate composed of two radio channels having a degree of similarity between BSSIDs thereof lower than that between two BSSIDs of two radio channels constituting the currently-connected radio channel pair.

### (Supplementary Note 3)

The control apparatus described in Supplementary note 1 or 2, wherein the channel selection control unit selects, from among a plurality of switching destination channel candidates, a switching destination channel candidate corresponding to a BSSID of which a degree of similarity with a BSSID of a first radio channel is lower than that between BSSIDs of the first radio channel and a second radio channel, which constitute the currently-connected radio channel pair, as a switching destination channel, and selects the first radio channel and the selected switching destination channel as the switching destination channel pair, and the channel switching control unit makes the radio communication apparatus disconnect the second radio channel and connect to the selected switching destination channel.

### (Supplementary Note 4)

The control apparatus described in Supplementary note 3, wherein

the BSSID includes six octets, and

the channel selection control unit determines a BSSID of which highest four octets of the six octets are different from those of the BSSID of the first radio channel to be a low-similarity BSSID, and selects a switching destination channel candidate corresponding to the low-similarity BSSID as the switching destination channel.

### (Supplementary Note 5)

The control apparatus described in Supplementary note 3, wherein

the BSSID includes six octets, and

the channel selection control unit selects, as the switching destination channel, a switching destination channel candidate corresponding to a BSSID of which a position of an octet which is different from that of the BSSID of the first radio channel is higher than those of other BSSIDs.

### (Supplementary Note 6)

The control apparatus described in Supplementary note 3, wherein

the BSSID includes six octets, and

the channel selection control unit determines a BSSID of which lowest two octets of the six octets are not continuous with those of the BSSID of the first radio channel to be a low-similarity BSSID, and selects a switching destination channel candidate corresponding to the low-similarity BSSID as the switching destination channel.

(Supplementary note 7)

The control apparatus described in Supplementary note 1, wherein

the channel selection control unit comprises:

a first selection processing unit configured to select, from among a plurality of switching destination channel candidates, a switching destination channel candidate corresponding to a BSSID of which a degree of similarity with a BSSID of a first radio channel is lower than that between BSSIDs of the first radio channel and a second radio channel, which constitute the currently-connected radio channel pair, as a temporarily-determined switching destination channel; and

a second selection processing unit configured to preferentially select, when a plurality of temporarily-determined switching destination channels are selected by the first selection processing unit, from among the plurality of temporarily-determined switching destination channels, a temporarily-determined switching destination channel corresponding to a channel frequency of which a degree of similarity with the channel frequency of the first radio channel is low as a switching destination channel, and select the first radio channel and the selected switching destination channel as the switching destination channel pair, wherein

the channel switching control unit makes the radio communication apparatus disconnect the second radio channel and connect to the switching destination channel selected by the second selection processing unit.

### (Supplementary Note 8)

The control apparatus described in Supplementary note 7, wherein

the BSSID includes six octets, and

the first selection processing unit determines a BSSID of which highest four octets of the six octets are different from those of the BSSID of the first radio channel to be a low-similarity BSSID, and selects a switching destination channel candidate corresponding to the low-similarity BSSID as the temporarily-determined switching destination channel.

### (Supplementary Note 9)

The control apparatus described in Supplementary note 7, wherein

the BSSID includes six octets, and

the channel selection control unit selects, as the temporarily-determined switching destination channel, a switching destination channel candidate corresponding to a BSSID of which a position of an octet which is different from that of the BSSID of the first radio channel is higher than those of other BSSIDs.

### (Supplementary Note 10)

The control apparatus described in Supplementary note 7, wherein

the BSSID includes six octets, and

the channel selection control unit determines a BSSID of which lowest two octets of the six octets are not continuous with those of the BSSID of the first radio channel to be a “low-similarity BSSID”, and selects a switching destination channel candidate corresponding to the low-similarity BSSID as the temporarily-determined switching destination channel.

(Supplementary note 11)

The control apparatus described in any one of Supplementary notes 7 to 10, wherein the second selection processing unit preferentially selects, as the switching destination channel, a temporarily-determined switching destination channel corresponding to a channel frequency having a channel number farthest from the channel number of the channel frequency of the first radio channel.

### (Supplementary Note 12)

The control apparatus described in any one of Supplementary notes 1 to 11, wherein the channel switching control unit assigns a common tunnel ID to both of two radio channels constituting the switching destination channel pair.

### (Supplementary Note 13)

A radio communication apparatus comprising a control apparatus described in any one of Supplementary notes 1 to 12.

### (Supplementary Note 14)

A control method performed by a control apparatus configured to control communication of a radio communication apparatus capable of simultaneously connecting to a plurality of radio channels, the control method comprising:

selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and

making the radio communication apparatus connect to the switching destination channel pair selected for the radio communication apparatus.

### (Supplementary Note 15)

A non-transitory computer-readable medium storing a control program for causing a control apparatus configured to control communication of a radio communication apparatus capable of simultaneously connecting to a plurality of radio channels to perform processes including:

selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and

making the radio communication apparatus connect to the switching destination channel pair selected for the radio communication apparatus.

### REFERENCE SIGNS LIST

1 COMMUNICATION SYSTEM
3 COMMUNICATION SYSTEM
10 ACCESS POINT (AP)
20 RADIO TERMINAL (RADIO COMMUNICATION APPARATUS)
21 RADIO UNIT (RADIO INTERFACE UNIT)
22 SWITCH
30 CONTROL UNIT (CONTROL APPARATUS)
31 CHANNEL SELECTION CONTROL UNIT
32 CHANNEL SWITCHING CONTROL UNIT
40 RADIO TERMINAL
50 CONTROL UNIT (CONTROL APPARATUS)
51 CHANNEL SELECTION CONTROL UNIT
51A FIRST SELECTION PROCESSING UNIT
51B SECOND SELECTION PROCESSING UNIT
52 CHANNEL SWITCHING CONTROL UNIT
70 GATEWAY APPARATUS
71 SWITCH

What is claimed is:

1. A control apparatus configured to control communication of a radio communication apparatus capable of simultaneously connecting to a plurality of radio channels, the control apparatus comprising:
at least one memory configured to store instructions; and
at least one processor configured to execute, according to the instructions, a process comprising:
selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and
making the radio communication apparatus connect to the switching destination channel pair selected for the radio communication apparatus.

2. The control apparatus according to claim 1, wherein the selecting includes selecting, as the switching destination channel pair, a switching destination channel pair candidate composed of two radio channels having a degree of similarity between BSSIDs thereof lower than that between two BSSIDs of two radio channels constituting the currently-connected radio channel pair.

3. The control apparatus according to claim 1, wherein
the selecting includes selecting, from among a plurality of switching destination channel candidates, a switching destination channel candidate corresponding to a BSSID of which a degree of similarity with a BSSID of a first radio channel is lower than that between BSSIDs of the first radio channel and a second radio channel, which constitute the currently-connected radio channel pair, as a switching destination channel, and selecting the first radio channel and the selected switching destination channel as the switching destination channel pair, and
the making includes making the radio communication apparatus disconnect the second radio channel and connect to the selected switching destination channel.

4. The control apparatus according to claim 3, wherein
the BSSID includes six octets, and
the selecting includes determining a BSSID of which highest four octets of the six octets are different from those of the BSSID of the first radio channel to be a low-similarity BSSID, and selecting a switching destination channel candidate corresponding to the low-similarity BSSID as the switching destination channel.

5. The control apparatus according to claim 3, wherein
the BSSID includes six octets, and
the selecting includes selecting, as the switching destination channel, a switching destination channel candidate corresponding to a BSSID of which a position of an octet which is different from that of the BSSID of the first radio channel is higher than those of other BSSIDs.

6. The control apparatus according to claim 3, wherein
the BSSID includes six octets, and
the selecting includes determining a BSSID of which lowest two octets of the six octets are not continuous with those of the BSSID of the first radio channel to be a low-similarity BSSID, and selecting a switching destination channel candidate corresponding to the low-similarity BSSID as the switching destination channel.

7. The control apparatus according to claim 1, wherein
the selecting including:
selecting, from among a plurality of switching destination channel candidates, a switching destination channel candidate corresponding to a BSSID of which a degree of similarity with a BSSID of a first radio channel is lower than that between BSSIDs of the first radio channel and a second radio channel, which constitute the currently-connected radio channel pair, as a temporarily-determined switching destination channel; and
preferentially selecting, when a plurality of temporarily-determined switching destination channels are selected by the first selection processing unit, from among the plurality of temporarily-determined switching destination channels, a temporarily-determined switching destination channel corresponding to a channel frequency of which a degree of similarity with the channel frequency of the first radio channel is low as a switching destination channel, and selecting the first radio channel and the selected switching destination channel as the switching destination channel pair, wherein
the making includes making the radio communication apparatus disconnect the second radio channel and connect to the switching destination channel selected by the second selection processing unit.

8. The control apparatus according to claim 7, wherein
the BSSID includes six octets, and
the selecting of the temporarily-determined switching destination channel includes determining a BSSID of which highest four octets of the six octets are different from those of the BSSID of the first radio channel to be a low-similarity BSSID, and selecting a switching destination channel candidate corresponding to the low-similarity BSSID as the temporarily-determined switching destination channel.

9. The control apparatus according to claim 7, wherein
the BSSID includes six octets, and
the selecting of the temporarily-determined switching destination channel includes selecting, as the temporarily-determined switching destination channel, a switching destination channel candidate corresponding to a BSSID of which a position of an octet which is different from that of the BSSID of the first radio channel is higher than those of other BSSIDs.

10. The control apparatus according to claim 7, wherein
the BSSID includes six octets, and
the selecting of the temporarily-determined switching destination channel includes determining a BSSID of which lowest channel to be a “low-similarity BSSID”, and selecting a switching destination channel candidate corresponding to the low-similarity BSSID as the temporarily-determined switching destination channel.

11. The control apparatus according to claim 7, wherein the preferentially selecting includes selecting, as the switching destination channel, a temporarily-determined switching destination channel corresponding to a channel frequency having a channel number farthest from the channel number of the channel frequency of the first radio channel.

12. The control apparatus according to claim 1, wherein the process comprises assigning a common tunnel ID to both of two radio channels constituting the switching destination channel pair.

13. A radio communication apparatus comprising a control apparatus according to claim 1.

14. A control method performed by a control apparatus configured to control communication of a radio communication apparatus capable of simultaneously connecting to a plurality of radio channels, the control method comprising:
selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and
making the radio communication apparatus connect to the switching destination channel pair selected for the radio communication apparatus.

15. A non-transitory computer-readable medium storing a control program for causing a control apparatus configured to control communication of a radio communication apparatus capable of simultaneously connecting to a plurality of radio channels to perform processes including:
selecting a switching destination channel pair from among a plurality of switching destination channel pair candidates in a plurality of radio channels based on a plurality of degrees of similarity each of which is a degree of similarly between two BSSIDs (Basic Service Set Identifiers) of two radio channels constituting a respective one of the plurality of switching destination channel pair candidates, and a degree of similarity between two BSSIDs of two radio channels constituting a currently-connected radio channel pair; and
making the radio communication apparatus connect to the switching destination channel pair selected for the radio communication apparatus.
